(19) United States
(12) Patent Application Publication
(10) Pub. No.: US 2009/0174648 A1
(43) Pub. Date: Jul. 9, 2009

(54) INTERNET CONNECTED DIGITAL PHOTO FRAME

(75) Inventors: Ah-Jee WANG, Taipei City (TW); Chi-Chou Lin, Taipei City (TW)

Correspondence Address: Muncy, Geissler, Olds & Lowe, PLLC, P.O. BOX 1364, FAIRFAX, VA, 22038-1364, US

(73) Assignee: D-Link Corporation

(21) Appl. No.: 12/062,228

(22) Filed: Apr. 3, 2008

(30) Foreign Application Priority Data
Jan. 8, 2008 (TW) 97100656

(51) Int. Cl. G09G 3/36

(52) U.S. Cl. 345/104

(57) ABSTRACT

For power saving and display, an internet connected digital photo frame is equipped with a sensor to detect an environment around it and a display to display in accordance with a detected effect. Furthermore, the internet connected digital photo frame displays internet connected digital contents at specific time by setting preset or determined time.

### BACKGROUND OF THE INVENTION

1. Field of the Invention

The present invention relates to an internet connected digital photo frame, and more specifically, to an internet connected digital photo frame with a power-saving design.

2. Background of the Related Art

Digital photo frames have been a popular small and middle-size display product in the recent years. In a research, the users of the digital photo frames tend to directly view and share photos on a display apparatus. Such a behavior model of customer leads the design tendency of the internet connected digital photo frames. Generally, a typical digital photo frame is equipped with a LCD screen with a high resolution for displaying photos in a good quality like a conventional photo film. Any amount of digital photos may be easily stored and displayed on the digital photo frame via the connection of a memory card, digital camera or computer. The memory card may be SD, MMC or MS cards or USB memory storage, and the playing formats supported by the digital photo frame may be static or motion JPEG, AVI or MGEG, even an audio format of MP3.

Accordingly, in the increasing population of the digital photo frame in a customer market, it is important to improve the functions and characteristics of the digital photo frame.

### SUMMARY OF THE INVENTION

The present invention is to provide an internet connected digital photo frame with a power-saving design which may alter a display type accordance with a viewer's presence and ambient lighting around the internet connected digital photo frame.

Further, besides the characteristic aforementioned, the present invention is to provide an internet connected digital photo frame for displaying an internet connected digital content at preset time. The internet connected digital content may be displayed at the preset time to save the power consumed by the internet connected digital photo frame.

Accordingly, one of embodiments of the present invention provides an internet connected digital photo frame which includes a signal processing module coupling with a transmission connecting module, an output controlling module, a sensing unit, a power module, a storage module and an output unit. The improvement includes: i) the sensing unit detecting whether a user is close to the internet connected digital photo frame or not; and/or ii) the sensing unit detecting the illumination intensity of a room and then transmitting a control signal to the signal processing module, and the signal processing module transmitting a command to the power module to alter power consumed by the output unit.

These and other aspects, features and advantages of the present invention can be further understood from the accompanying drawings and description of a preferred embodiment.

### BRIEF DESCRIPTION OF THE DRAWINGS

FIG. 1 is a block diagram illustrating an internet connected digital photo frame in accordance with one embodiment of the present invention.

FIG. 2A is a block diagram illustrating the signal processing module of an internet connected digital photo frame in accordance with one embodiment of the present invention.

FIG. 2B is a block diagram illustrating the output controlling module of an internet connected digital photo frame in accordance with one embodiment of the present invention.

FIG. 3 is a block diagram illustrating the power module of an internet connected digital photo frame in accordance with one embodiment of the present invention.

### DETAILED DESCRIPTION OF THE INVENTION

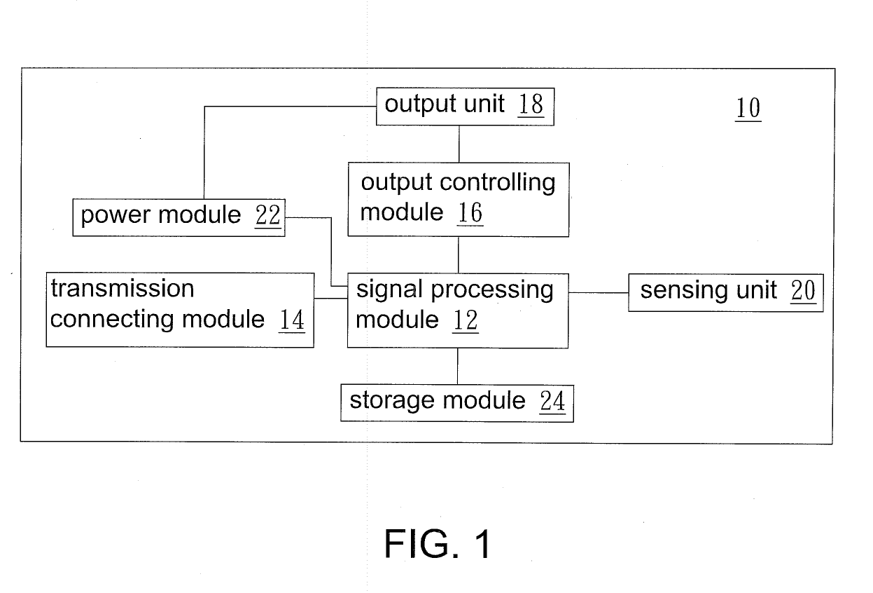

FIG. 1 is a block diagram illustrating an internet connected digital photo frame in accordance with one embodiment of the present invention. An internet connected digital photo frame 10 includes a signal processing module 12, a transmission connecting module 14, an output controlling module 16, an output unit 18, a sensing unit 20, a power module 22 and a storage module 24. As shown in FIG. 1, the signal processing module 12 is coupled with the transmission connecting module 14, the output controlling module 16, the sensing unit 20 and the storage module 24. The power module 22 is coupled with the output unit 18 and the signal processing module 12. The output unit 18 is coupled with the output controlling module 16.

In an embodiment, the sensing unit 20, such as an IR sensor or proximity sensor or light sensor, is configured for: i) detecting whether one or more viewers or users are close to the internet connected digital photo frame 10 or not; and/or ii) detecting the ambient light intensity of a room whether bright or dim, and transmitting a control signal to the signal processing module 12. Alternatively, the sensing unit 20 is further configured for receiving other control signal from a remote control (not shown in the figure) and then transmitting the other control signal to the signal processing module 12.

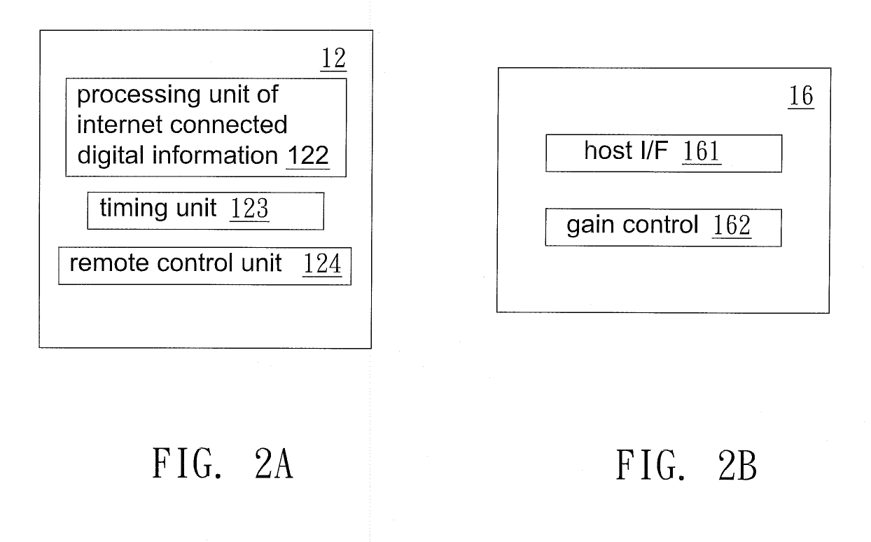

Shown in FIG. 2A, the signal processing module 12 includes, but not limit to, a processing unit of internet connected digital information 122, a timing unit 123 (T-COM) and a remote control unit 124. In the embodiment, the processing unit of internet connected digital information 122 is configured for operating, identifying, decoding and transforming internet connected digital information to data in a displayable format, such as TIF, PNG, JPG, BMP or GIG format. In the embodiment, the internet connected digital information may be an internet digital content or contents provided by the web service of Web log, RSS or SNS. The timing unit 123 is configured for time preset to enable the internet connected digital photo frame to transmit or access the internet connected digital information at preset time. Alternatively, when the sensing unit 20 may receive the control signal of the remote control, the remote control unit 124 processes the control signal of the remote control. The signal processing module 12 is coupled with the storage module 24 to access the internet connected digital information. The storage module 24 may be a built-in flash memory, hard disk driver, storage memory, compact flash (CF), secure internet connected digital card (SD) or memory stick or the combinations thereof. Furthermore, the signal processing module 12 is coupled with the transmission connecting module 14 to receive or transmit the internet connected digital information. The transmission connecting module 14 may include various interfaces or connect ports to link to a network. The transmission connecting module 14 may be the transmission line interface of a computer photo. The transmission line interface may be a RS 232 interface, USB 2.0 interface, IEEE1394 interface, PCMCIA interface or the transmission line interface of a home network, such as a powerline interface, Home Phoneline Networking Alliance 3.0/3.1 interface, Homeplug interface and Multimedia over coax alliance interface or the combinations thereof, and so on. In a preferred embodiment, the transmission connecting module 14 includes a wireless transmission interface, such as Wi-Fi, 3G, 3.5G, Bluetooth, Wibree, Home Radio Frequency and WiMax standard interfaces or the combinations thereof. Next, the signal processing module 12 is coupled with the output controlling module 16, shown in FIG. 2B. The output controlling module 16, such as a display-controlling unit, includes but not limits to a host I/F 161 and a gain control 162. The host I/F 161 is coupled with the output unit 18. The gain control 162 modifies the display of the output unit 18 in accordance with the control signal from signal processing module 12. Alternatively, the signal processing module 12, the output controlling module 16 and the transmission connecting module 14 are integrated into a. system-on-a-chip.

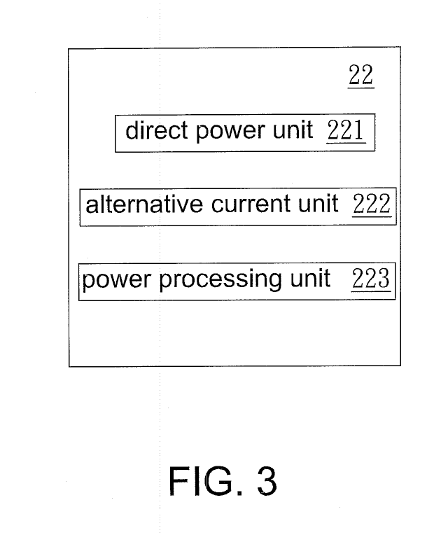

Referring to FIG. 3, the power module 22 is configured for managing the power consumed by the internet connected digital photo frame 10, which includes a direct power unit 221, an alternative current unit 222 and a power processing unit 223. In the embodiment, the direct power unit 221 is a battery to supply power. The alternative current unit 222 supplies alternative current to charge the direct power unit 221. The power processing unit 223 transforms the power from the direct power unit 221 or the alternative current unit 222 into the power necessary for the output unit 18. Furthermore, the output unit 18 may be a display, such as a LCD display, OLED display or PDD display.

Accordingly, the sensing unit 20 transmits the control signal which represents a user or viewer's presence to the signal processing module 12 or the ambient light intensity of the environment. The signal processing module 12 analyzes the control signal to determine the display of the internet connected digital information. On one hand, when the control signal represents no one is around the internet connected digital photo frame 10 or the ambient light is low, the signal processing module 12 sends a command for interrupting the display of the internet connected digital information to render the internet connected digital photo frame 10 stand in a standby state for power saving. On the other hand, the command for interrupting playing or displaying is also sent to the power module 22. The power module 22 alters the display effects of the output unit 18, such as reduces or turns off the brightness of the output unit 18. On the other hand, when anyone is close to the internet connected digital photo frame 10 or the ambient light is increased the signal processing module 12 sends a display command to drive the internet connected digital photo frame from the standby state. The power module 22 may alter the display of the output unit 18, such as recover or turn on the brightness of the output unit 18. Accordingly, the internet connected digital photo frame of the present invention may provide various display effects and play effects in accordance with the existence of a user or viewer around the internet connected digital photo frame and/or the ambient intensity of the environment.

Next, the internet connected digital information may be displayed or played at the preset time. For example, the internet connected digital information is a customized content, which may be established in the web sites of Portal Service or Aggregator. At the preset time, the signal processing module 12 may send a displaying command to display the customized content. An updated content may be transmitted via the transmission connecting module 14 according to the displaying command to the signal processing module 12. Then the updated content together with the existed content in the storage unit is transmitted to the output controlling module 16 and then displayed by the output unit 18. Accordingly, the internet connected digital photo frame of the present invention may provide the latest content according to the user's presetting and play the role of a flash bulletin. Thus, without use of a computer, a user may review any internet content with the internet connected digital photo frame.

Although the present invention has been explained in relation to its preferred embodiment, it is to be understood that other modifications and variation can be made without departing the spirit and scope of the invention as hereafter claimed.

What is claimed is:

1. An internet connected digital photo frame comprising a signal processing module coupling with a transmission connecting module, an output controlling module, a sensing unit, a power module, a storage module and an output unit, the improvement comprising:
the sensing unit at least one of detecting whether a user is close to the internet connected digital photo frame or not and detecting the ambient lighting condition and then transmitting a control signal to the signal processing module; and
the signal processing module transmitting a command to the power module to alter power consumed by the output unit.

2. An internet connected digital photo frame according to claim 1, wherein the output controlling module further couples with the output unit.

3. An internet connected digital photo frame according to claim 2, wherein the signal processing module, the output controlling module and the transmission connecting module are integrated into a system-on-a-chip.

4. An internet connected digital photo frame according to claim 1, wherein the signal processing module comprises a timing unit configured for providing a preset time.

5. An internet connected digital photo frame according to claim 4, wherein the transmission connecting module provides the output unit with internet connected digital information for an output.

6. An internet connected digital photo frame according to claim 5, wherein the internet connected digital information comprises an internet digital content.

7. An internet connected digital photo frame according to claim 5, wherein the internet connected digital information comprises internet connected digital photos.

8. An internet connected digital photo frame according to claim 1, wherein, when the control signal represents no viewer around the internet connected digital photo frame or when the ambient light is low, the command renders the internet connected digital photo frame to a standby power saving state.

9. An internet connected digital photo frame according to claim 8, wherein, when the output unit is a screen, the power module reduces or turn off the brightness of the screen under the command.

10. An internet connected digital photo frame according to claim 1, wherein the storage module is a built-in flash memory, hard disk driver, storage memory, compact flash, secure internet connected digital card or memory stick or the combinations thereof.

11. An internet connected digital photo frame according to claim 1, wherein the transmission connecting module is a transmission line interface of computer images and comprises RS232 interface, USB 2.0 interface, IEEE1394 interface and PCMCIA interface or the combinations thereof.

12. An internet connected digital photo frame according to claim 1, wherein the transmission connecting module is a wireless transmission interface and comprises Wi-Fi, 3G, 3.5G, Bluetooth, Wibree, Home Radio Frequency and WiMax standard interfaces or the combinations thereof.

13. An internet connected digital photo frame according to claim 1, wherein the transmission connecting module is a home network transmission interface and comprises powerline interface, Home Phoneline Networking Alliance 3.0/3.1 interface, Homeplug interface and Multimedia over coax alliance interface or the combinations thereof.

14. An internet connected digital photo frame comprising a signal processing module coupling with a transmission connecting module, an output controlling module, a sensing unit, a power module, a storage module and a display unit, the improvement comprising:
the sensing unit detecting at least one of whether a user is close to the internet connected digital photo frame and the ambient lighting condition and then transmitting a control signal to the signal processing module;
the signal processing module transmitting a command to the power module to tune power consumed by the display unit; and
the display unit, at a preset time, displaying internet connected digital information from the transmission connecting module.

15. An internet connected digital photo frame according to claim 14, wherein the internet connected digital information comprises contents from Portal Services and Aggregator websites.

16. An internet connected digital photo frame according to claim 14, wherein the signal processing module, the display unit and the transmission connecting module are integrated into a system-on-a-chip.

17. An internet connected digital photo frame according to claim 14, wherein the transmission connecting module is a transmission line interface of computer images and comprises RS232 interface, USB 2.0 interface, IEEE1394 interface and PCMCIA interface or the combinations thereof.

18. An internet connected digital photo frame according to claim 14, wherein the transmission connecting module is a wireless transmission interface and comprises Wi-Fi, 3G, 3.5G, Bluetooth, Wibree, Home Radio Frequency and WiMax standard interfaces or the combinations thereof.

19. An internet connected digital photo frame according to claim 14, wherein the transmission connecting module is a home network transmission interface and comprises powerline interface, Home Phoneline Networking Alliance 3.0/3.1 interface, Homeplug interface and Multimedia over coax alliance interface or the combinations thereof.

20. An internet connected digital photo frame according to claim 14, wherein the storage module is a built-in flash memory, hard disk driver, storage memory, compact flash, secure internet connected digital card or memory stick or the combinations thereof.
